(19) United States
(12) Patent Application Publication
(10) Pub. No.: US 2011/0123074 A1
(43) Pub. Date: May 26, 2011

(54) SYSTEMS AND METHODS FOR SUPPRESSING ARTIFICIAL OBJECTS IN MEDICAL IMAGES

(75) Inventors: Yao Nie, Sunnyvale, CA (US); Chao Shi, San Jose, CA (US); Nariman Majdi-Nasab, San Jose, CA (US); Akira Hasegawa, Saratoga, CA (US)

(73) Assignee: FUJIFILM CORPORATION, Tokyo (JP)

(21) Appl. No.: 12/626,586

(22) Filed: Nov. 25, 2009

(51) Int. Cl. G06K 9/00

(52) U.S. Cl. 382/128

(57) ABSTRACT

A system and method are provided for altering the appearance of an artificial object in a medical image. An artificial object is first identified in the medical image, such as identifying a breast implant in a mammography image. The prominence of the artificial object is then reduced, for example by suppressing the brightness or masking the artificial object out altogether. The resulting medical image with the altered artificial object is then displayed to a user so that the medical image can be more accurately analyzed without requiring the user to adjust the image on his or her own.

### BACKGROUND

1. Field

The systems and methods described below relate to altering the appearance of an artificial object in a medical image, and more specifically to suppressing or masking an artificial object in a medical image such as a mammography image.

2. Background

Medical imaging relates to the field of creating images of the human body for medical purposes, such as diagnosing or examining disease or other physiological anomalies. Numerous types of image modalities produce medical images, such as magnetic resonance imaging (MRI), radiography (x-rays), computed tomography (CT), ultrasound (US) and others. In medical imaging, an object of interest is usually selected pertaining to an area of the human body, such as the head, heart or chest.

One type of medical imaging is mammography, which is the examination of a medical image of the human breast. Mammography is used to detect breast cancer by examining the breast tissue for abnormalities such as microcalcifications or uncharacteristic masses.

In mammography images, there may be artificial, non-breast objects that appear extremely bright in the image, which can be very distracting to the radiologist who needs to analyze the breast tissue. Examples of some artificial objects include pacemakers, breast implants, lead markers, BB markers, magnifier frames, wires left from previous surgery or unexposed areas on a detector, etc. As depicted in the mammography image 100 in FIG. 1A, when an implant 102 presents in the mammography image, the brightness of the implant 102 may dominate the image 100, thus obscuring the surrounding tissue 104 that is of interest. In these cases, a user examining the image, such as a radiologist, will often invert the image contrast, as shown in FIG. 1B, to make the implant 102 appear dark before the reading can be performed. However, simply inverting the image affects the entire image as opposed to simply adjusting the brightness of the implant. If the user wishes to perform other adjustments to the image, the process can be time consuming, tedious, thus discouraging the user from attempting to obtain the clearest possible image with the best chance of diagnosing any potential issue.

Thus, it is desired to develop systems and methods for improving the quality of a medical image so that a user does not have to spend time adjusting the image, and particularly a mammography image, when an artificial object is present.

### SUMMARY

Various embodiments of the invention relate to systems and methods for altering the appearance of an artificial object in a medical image, and more specifically to suppression or masking of an artificial object in a medical image such as a mammography image. At least one artificial object in a medical image is identified, after which the appearance of the artificial object is altered by reducing its prominence, leaving the remaining image unaltered. The medical image with the altered artificial object is then displayed to a user.

One embodiment of the invention relates to a method for altering the appearance of an artificial object in a medical image, comprising the steps of identifying at least one artificial object in a medical image; reducing the prominence of the artificial object to create an altered artificial object; and displaying the medical image with the altered artificial object on a display.

In another embodiment of the invention, reducing the prominence of the object comprises suppressing the brightness of the artificial object to reduce the prominence of the object.

In a further embodiment of the invention, reducing the prominence of the object comprises masking out the artificial object to reduce the prominence of the object.

In still another embodiment of the invention, reducing the prominence of the artificial object comprises covering up the artificial object with a simulated tissue image.

In a yet further embodiment of the invention, identifying the at least one artificial object comprises processing the medical image using a region grow method.

In a further embodiment of the invention, identifying at least one artificial object for which the prominence is to be reduced by detecting all objects above a minimum threshold of brightness.

In still another embodiment of the invention, identifying the at least one artificial object is performed automatically.

In a yet further embodiment of the invention, the medical image is a mammography image containing an image of a human breast.

In another embodiment of the invention, the object comprises a primary object located inside an area of the breast and a secondary object located outside the area of the breast, wherein the prominence of the object is reduced by suppressing the brightness of the primary object and masking out the secondary object.

In a further embodiment of the invention, the at least one artificial object is a pacemaker, breast implant, lead marker, BB marker, magnifier frame, or unexposed area of the medical image.

Embodiments of the invention also relate to a system for altering the appearance of an artificial object in a medical image, comprising an identifying unit which identifies at least one artificial object in the medical image; a reduction unit which reduces the prominence of the artificial object to create an altered artificial objection; and a display unit which displays the medical image with the altered artificial object on a display.

In another embodiment of the invention, the system further comprises a display unit which displays the medical image with the altered artificial object on a display.

In a further embodiment of the invention, the reduction unit reduces the prominence of the artificial object by suppressing the brightness of the artificial object.

In still another embodiment of the invention, the system further comprises a reduction unit reduces the brightness of the artificial object by masking out the artificial object.

In a yet further embodiment of the invention, the reduction unit reduces the prominence of the artificial object by covering up the artificial object with a simulated tissue image.

In yet another embodiment of the invention, the at least one artificial object is identified using a region grow method.

In another embodiment of the invention, the identifying unit identifies the at least one artificial object by detecting all objects above a minimum threshold of brightness.

In a further embodiment of the invention, the at least one artificial object is identified automatically.

In still another embodiment of the invention, the medical image is a mammography image containing an image of the human breast.

In a yet further embodiment of the invention, the object comprises a primary object located inside an area of the breast and a secondary object located in an area outside of the breast, wherein the prominence of the object is reduced by suppressing the brightness of the primary object and masking out the secondary object.

In a further embodiment of the invention, at least one artificial object comprises a pacemaker, a breast implant, a lead marker, a magnifier frame, or an unexposed area of the medical image.

Embodiments of the invention also relate to a computer program product for altering the appearance of an artificial object in a medical image, the computer program product embodied on a computer readable medium and when executed by a computer, performs the method comprising identifying at least one artificial object in a medical image; reducing the prominence of the artificial object to create an altered artificial object; and displaying the medical image with the altered artificial object on a display

Additional embodiments of the invention will be set forth in part in the description which follows, and in part will be apparent from the description, or may be learned by practice of the invention. Embodiments of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify various embodiments of the present invention and, together with the description, serve to explain and illustrate principles of the inventive technique. Specifically:

FIG. 1A depicts a mammography image showing a breast with an implant, as is known in the art;

FIG. 1B depicts a mammography image where the intensity of the image has been inverted, as is known in the art;

FIG. 2A depicts a mammography image where the implant has been suppressed to reduce the brightness, according to one embodiment of the invention;

FIG. 2B depicts a mammography image where the implant has been masked out to reduce the brightness, according to one embodiment of the invention;

FIG. 3 depicts a mammography image showing a breast with a pacemaker, as is known in the art;

FIG. 4 depicts a mammography image where the pacemaker has been suppressed to reduce the brightness, according to one embodiment of the invention;

FIG. 5 depicts a mammography image where the pacemaker, an unexposed area of the mammography image and a lead marker have been suppressed to reduce the brightness, according to one embodiment of the invention;

FIG. 6 depicts a mammography image where the pacemaker has been suppressed, while the unexposed area of the mammography image and a lead marker have been masked out, according to one embodiment of the invention;

FIGS. 7A and 7B depict a mammography image where the artificial object is covered up by an artificial tissue image, according to a further embodiment of the invention;

FIGS. 8A-8C depict methods of altering the appearance of an artificial object in a medical image, according to various embodiments of the invention;

FIG. 9 illustrates a system for altering the appearance of an artificial object in a medical image, according to one embodiment of the invention; and

FIG. 10 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

Various embodiments of the invention relate to systems and methods for altering the appearance of an artificial object in a medical image, and more specifically to suppression or masking of an artificial object in a medical image such as a mammography image. At least one artificial object in a medical image is identified, after which the appearance of the artificial object is altered by reducing its prominence, leaving the remaining image unaltered. The medical image with the altered artificial object is then displayed to a user.

By identifying and altering the appearance of the artificial object, the systems and methods described herein aid a user reviewing the medical images by saving the user significant time and effort that would otherwise be spent altering the image manually. Additionally, the systems and methods described herein are capable of altering only the artificial object as opposed to the entire image, thereby preserving the clarity of the areas of interest, such as tissue and bone, in the original image. The user viewing the medical image, for example a radiologist, can more clearly view and more accurately identify any potential areas of interest without the distraction of the bright artificial object.

The inventive systems and methods are applicable to many types of medical imaging, including but not limited to magnetic resonance imaging (MRI), radiography (x-rays), computed tomography (CT) and ultrasound (US). In most types of medical imaging, artificial objects such as breast implants, pacemakers, lead markers, magnifier frames or unexposed areas in the detector present as bright, intense objects that are visually distracting to a user viewing the image. The inventive systems and methods may be implemented on a computer system separate from the imaging equipment which captures the image, and can also be implemented on a computer system which first processes the raw image using other image processing techniques before conducting the embodied image processing techniques described herein.

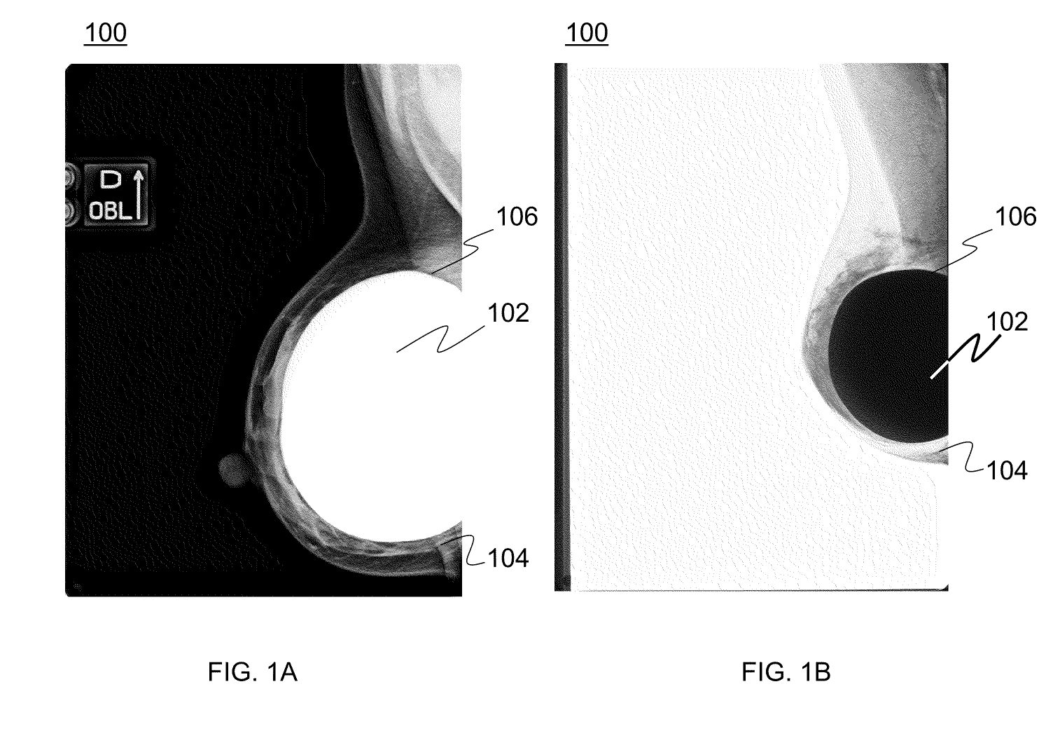

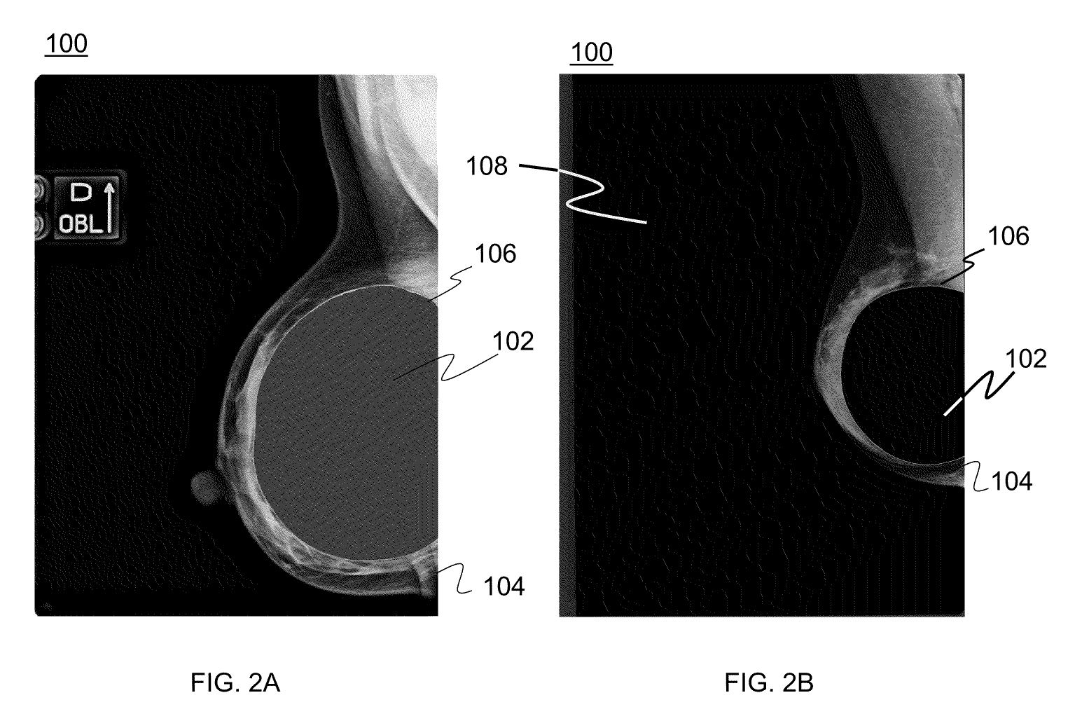

Identification of an artificial object in a medical image can be accomplished by detecting bright areas of the image which are confined by strong and smooth boundaries. The breast implant 102 in FIG. 1A is one example, as the boundary 106 of the implant is clearly defined in the image 100 as having a smooth boundary with a distinct contrast between the implant 102 and the surrounding tissue 104. Image processing software on a computer may carry out the identification of the object and automatically find and detect the whole artificial object, or in an alternative embodiment, a user can initiate finding the whole artificial object, for example, by just identifying a point inside the artificial object or an area which includes at least part of the object using a computer with a display, where the image processing software on a computer then detects the boundary of the object. The user may identify an object by clicking on the object with a mouse or using a tablet-type input device to outline an area which includes at least part of the object.

Various image processing techniques, such as region grow, can be used for segmenting the artificial objects to determine their boundaries. Segmentation is performed automatically by a computer, and partitions the image into a plurality of segments that are then classified to determine segments that have similar characteristics, such as intensity and texture. In the region grow method, which can be performed automatically by a computer, different regions of an image are selected, iteratively grown and then comparatively classified. The region grow method will identify an artificial object and identify the boundaries of the artificial object. As region grow is a conventional image processing technique, it will not be further described here. The region grow method is effective since the artificial objects usually have uniform intensities. Again, the breast implant 102 is illustrative, as it has a solid white color over its entire surface. Other image segmentation methods known to one of skill in the art, such as histogram-based methods or edge detection, may also be used.

The following illustrative embodiments pertain to mammography images, but one skilled in the art will appreciate that the methods and systems described herein can be applied to any medical image of any area of the body that may contain artificial objects. For example, screws, plates and pins often inserted in the body to attach broken bones may also present as bright, intense objects on a medical image, such that altering their appearance would also be beneficial to an examining medical professional. In any medical image, the inventive systems and methods allow the user to define an object of interest and alter the appearance of any object other than the object of interest.

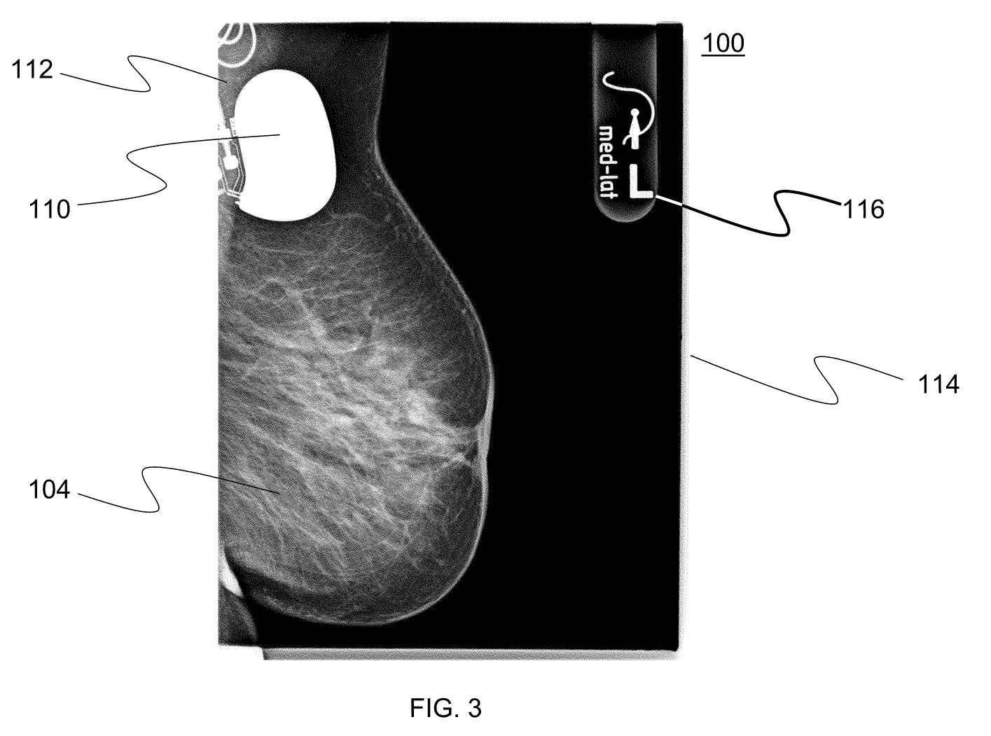

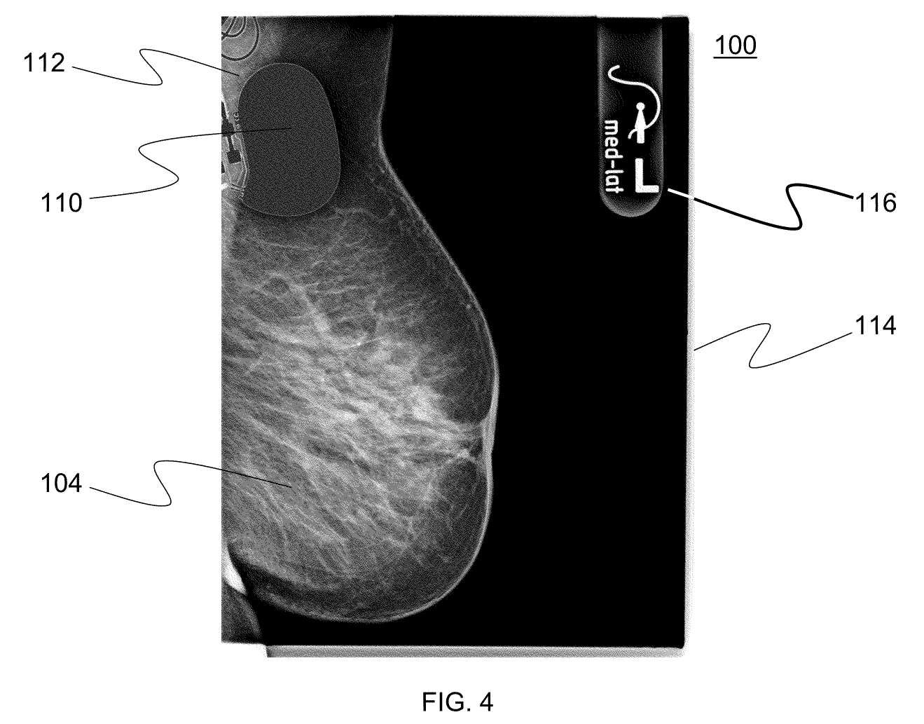

In a first embodiment of the invention, illustrated by the mammography image 100 in FIG. 2A, the artificial object identified is a breast implant 102. The mammography image 100 from FIG. 1A is the identical original mammography image 100 prior to application of the inventive method. Once the artificial object has been identified as, in this case, the breast implant 102, its prominence is reduced by suppressing the brightness, as shown by the altered breast implant 102 in FIG. 2A. Suppressing the brightness includes reducing the brightness of the artificial object by a certain amount or a certain ratio. The original intensity of the pixels is suppressed by a reduction amount, or if the intensity is reduced by a certain ratio, the suppressed pixel intensity equals the original pixel intensity multiplied by a reduction ratio, which is a value greater than zero and less than 1.

In one embodiment, the breast implant's brightness is suppressed to the point that it appears less prominent than the surrounding breast tissue 104. The amount of reduction of the brightness may vary depending on a user preference and can be set to a predetermined level. In order to suppress the brightness to a level below that of the surrounding breast tissue, the brightness of each area must be compared so that the appropriate reduction can be accomplished. In one embodiment, the brightness of the artificial object is automatically reduced to a predetermined level. For example, the intensities of the pixels inside the artificial object can be reduced by a same amount so that the highest intensity inside the object is less or equal to the lowest intensity outside the object. In a further embodiment, after the artificial object is automatically reduced, the user is able to adjust the brightness level further to achieve a desirable level of reduction.

In an alternate embodiment, illustrated in FIG. 2B, the breast implant 102 can be masked out, or covered up completely. In one embodiment, when an object is masked out, the intensity value of the object is reduced to zero, as is illustrated in FIG. 2B. The pixel intensity value may also be reduced to a single intensity value to eliminate an intensity variation in the artificial object that may be distracting to a user. Suppressing the image, in contrast, will not affect the variations in the intensity. By masking out the object, it is essentially completely removed from the image so that none of the intensity variations within the object are visible. In comparison, suppressing the object will keep any distracting visual features of the object in the image, although reduced. The masked object may have the same brightness, or lack of brightness, as the surrounding tissue 104, or be as dark as the background 108 of the image.

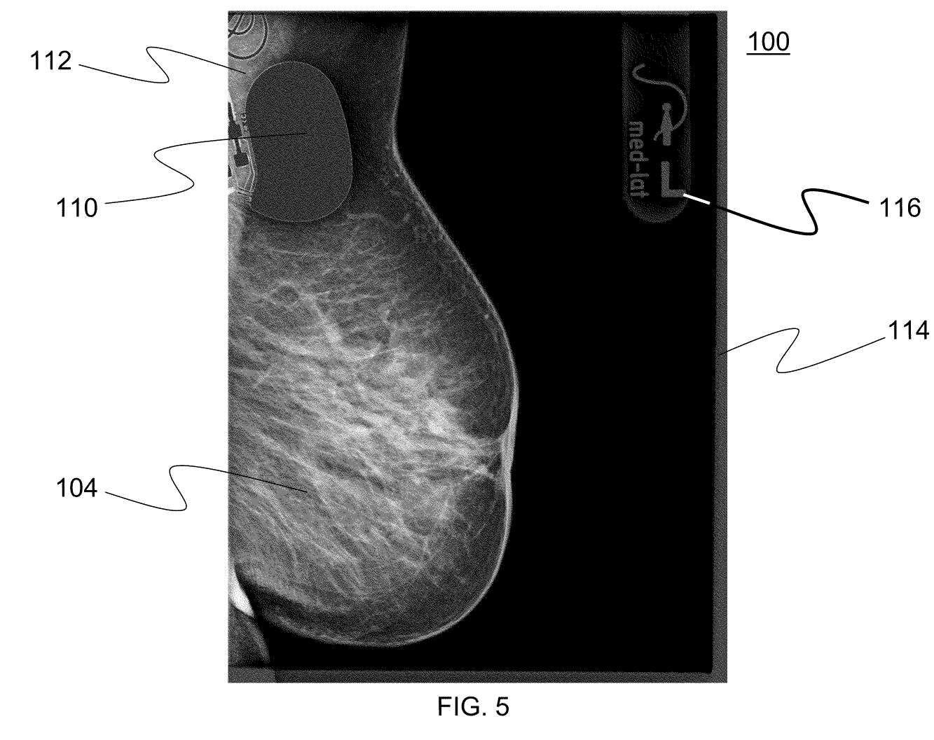

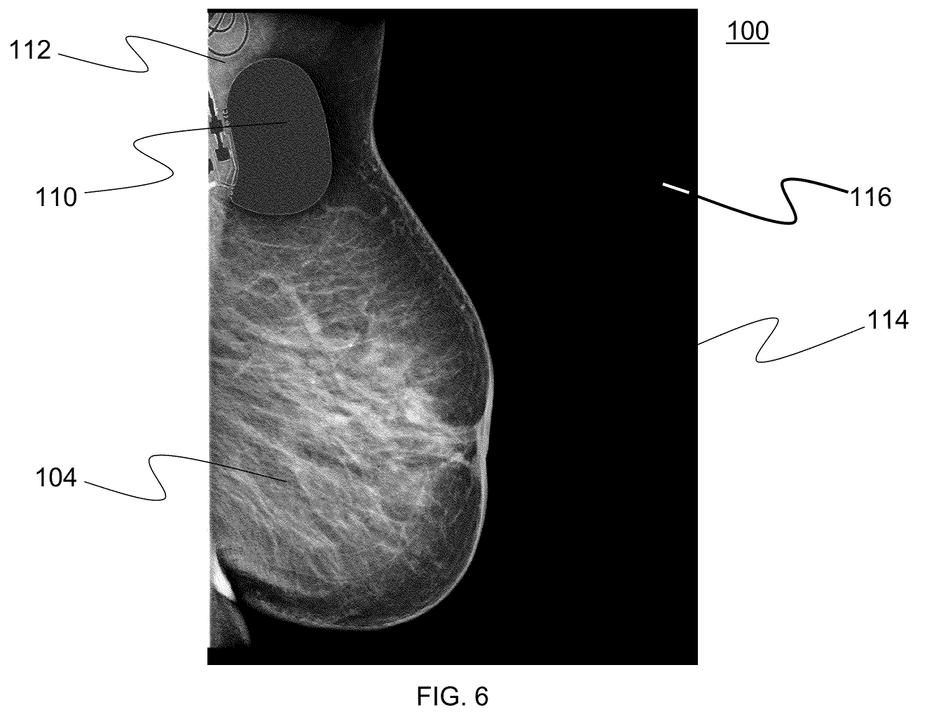

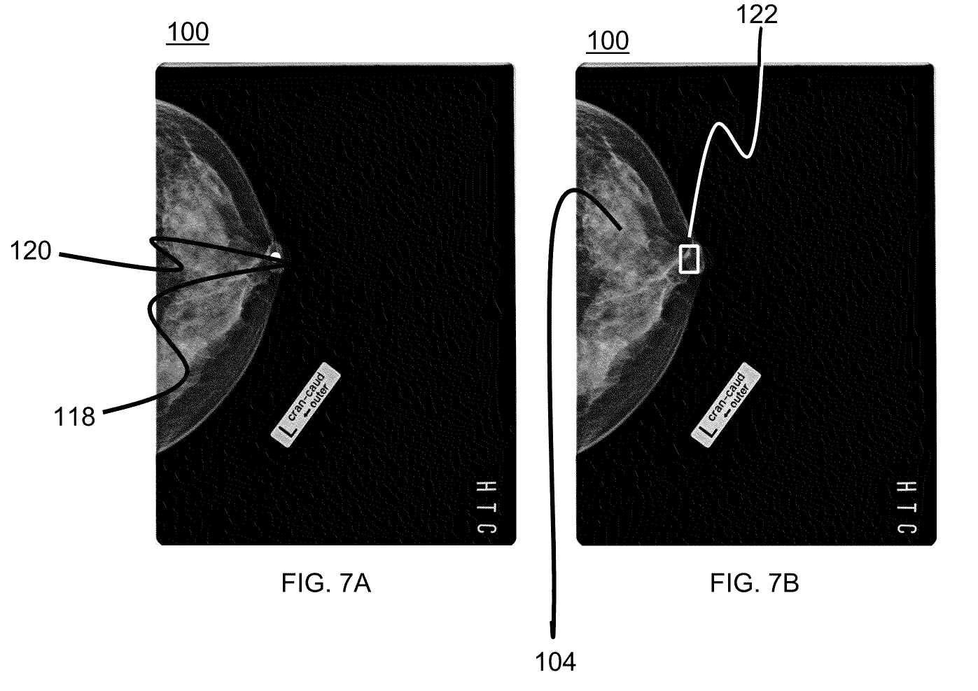

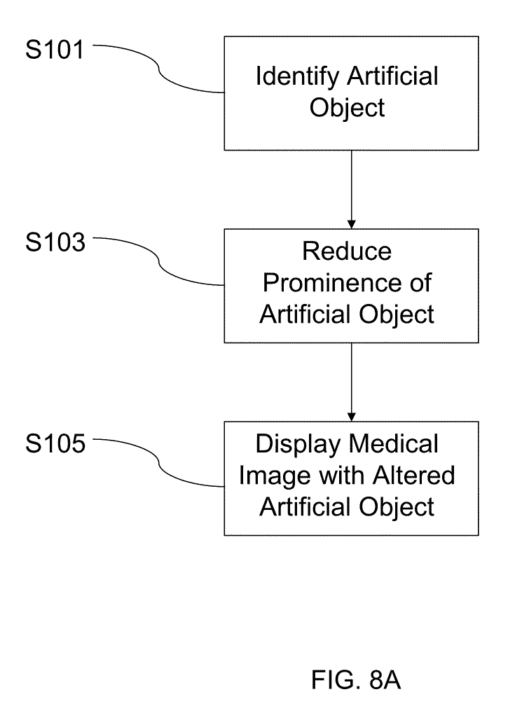

In one embodiment, the type of artificial object is detected, after which the prominence of the artificial object is reduced by suppressing the brightness or masking out the object, as discussed above. For example, in FIG. 3, a pacemaker 110 is depicted as it would look in an original, unaltered image 100. An unexposed area 114 of the image and a lead marker 116 are also shown, although it should be noted that the unexposed area 114, which represents a white, bright area, is not clearly visible in FIG. 3 due to the white background of the page. It will be more clearly visible in FIGS. 5-6, below. FIG. 4 illustrates the pacemaker 110 after the inventive method has been applied to identify the pacemaker in the image 100 and suppress the brightness. The leader maker and the unexposed area in the image are unaltered.

To determine the type of artificial object present in a medical image, in one embodiment, the type of artificial object can be differentiated by the shape, size and location of the object. For example, the implant is basically round, as large as almost the whole breast, and located in the center of the breast; the pacemaker is also round, but usually much smaller than the breast, and located on the pectoral muscle area; the lead marker is rectangular and located outside the breast. In one embodiment, the system is configured to suppress the implant only, as it is the most prominent artificial object in the breast. In this case, the system searches for round and large bright object inside the breast which is below the pectoral muscle. In an alternate embodiment, the user can click on the implant on a computer display to indicate the object she/he wants to suppress. Or the user can define a size threshold such that all the artificial objects which are larger than the given threshold will be suppressed.

In another embodiment, all extremely bright objects are identified in the image in order to identify the artificial objects. The level of brightness can be set at a threshold level, so that any object detected with a brightness level above the threshold is identified as an artificial object. As described above, the brightness of the artificial objects is then suppressed, or the artificial objects are completely masked out, depending on a user preference. For example, FIG. 5 shows that the pacemaker 110, lead marker 116 and the unexposed area 114 are all suppressed, indicating that they met a certain threshold of brightness.

FIGS. 4 and 5 illustrate a further embodiment of the invention where an unexposed area 114 of the mammography image 100 in FIG. 4 is identified and suppressed, as illustrated by the now reduced brightness level of the unexposed area 114 in FIG. 5. FIG. 5 also illustrates the suppression of a lead marker 116. FIG. 4 therefore illustrates the suppression of only a single object, the pacemaker 110, while FIG. 5 illustrates the suppression of all objects, including the pacemaker 110, unexposed area 114 and lead marker 116.

In a further embodiment, the system is configured to mask out artificial objects which lie outside an area of the image pertaining to the breast, while artificial objects that lie inside the breast area only have their brightness suppressed. In such an embodiment illustrated in FIG. 6, the pacemaker 110, which falls within a breast area, is suppressed, while the unexposed area 114 and lead marker 116 are masked out.

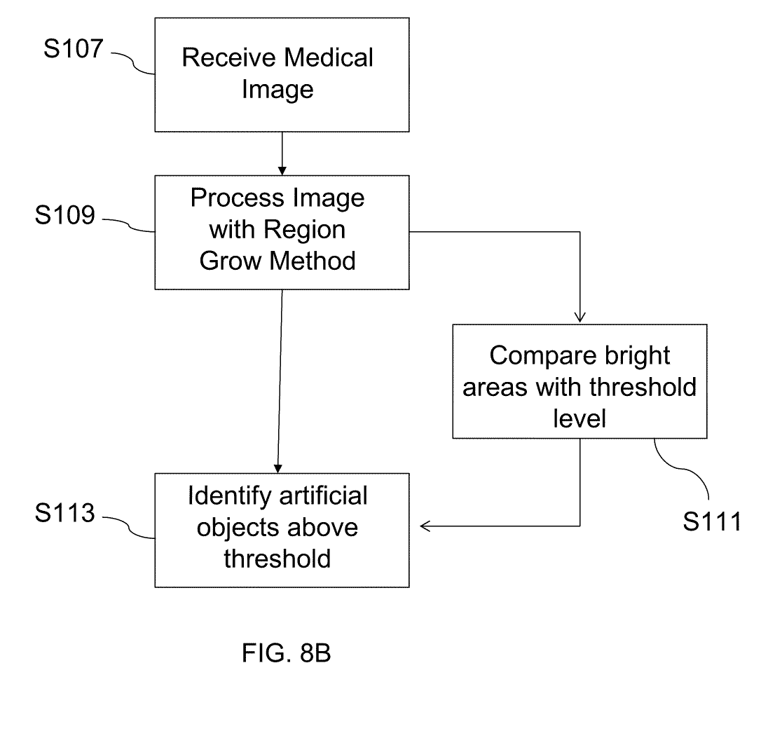

In still another embodiment, the artificial object may be covered up by an image of tissue that looks similar to the surrounding tissue, as illustrated in FIGS. 7A and 7B. In FIG. 7A, the mammography image 100 depicts a breast where a nipple 118 has been marked with a BB marker 120, which is a physical marker that is placed on the breast by a technician to indicate the location of the nipple before the mammography image 100 is taken. In FIG. 7B, the BB marker is covered by a simulated tissue image 122, which is visually indistinguishable from the breast tissue 104 surrounding the nipple. The simulated tissue image 122 could be generated by interpolation from pixels surrounding the BB marker 120. While the use of an artificial tissue image is effective for small areas such as the BB marker, it may be possible to use a larger simulated image to cover a larger object of interest.

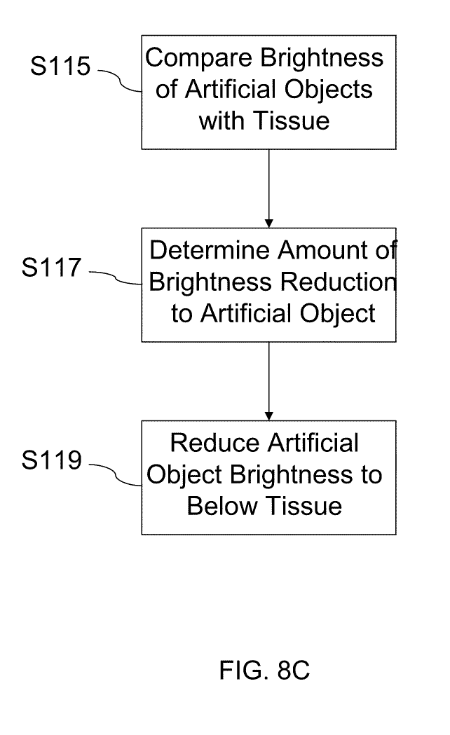

FIG. 8A depicts a method for altering the appearance of an artificial object, according to one embodiment of the invention. In a first step S101, at least one artificial object is identified in a medical image. In a second step S103, the prominence of the artificial object is reduced to create an altered artificial object. Finally, in step S105, the medical image with the altered artificial object is displayed on a display.

FIG. 8B depicts one embodiment of a method of identifying artificial objects in a medical image, including first receiving a medical image S107. In a next step S109, the image is processed using a region grow method to identify bright areas in the image that may correspond to artificial objects. In an optional step S111, the identified bright areas are compared with a threshold level of brightness to determine if they need to be suppressed. Finally, the objects which meet the threshold level are identified as artificial objects that need to be suppressed in a final step S113.

FIG. 8C depicts one embodiment of a method of reducing the prominence of an artificial object in a medical image. In a first step S115, the brightness of the at least one artificial object is compared with the brightness of the surrounding tissue. In a second step S117, the level of reduction of brightness is determined so that the at least one artificial object will appear less bright than the surrounding tissue. In a third step S119, the brightness of the at least one artificial object is reduced by the previously determined amount.

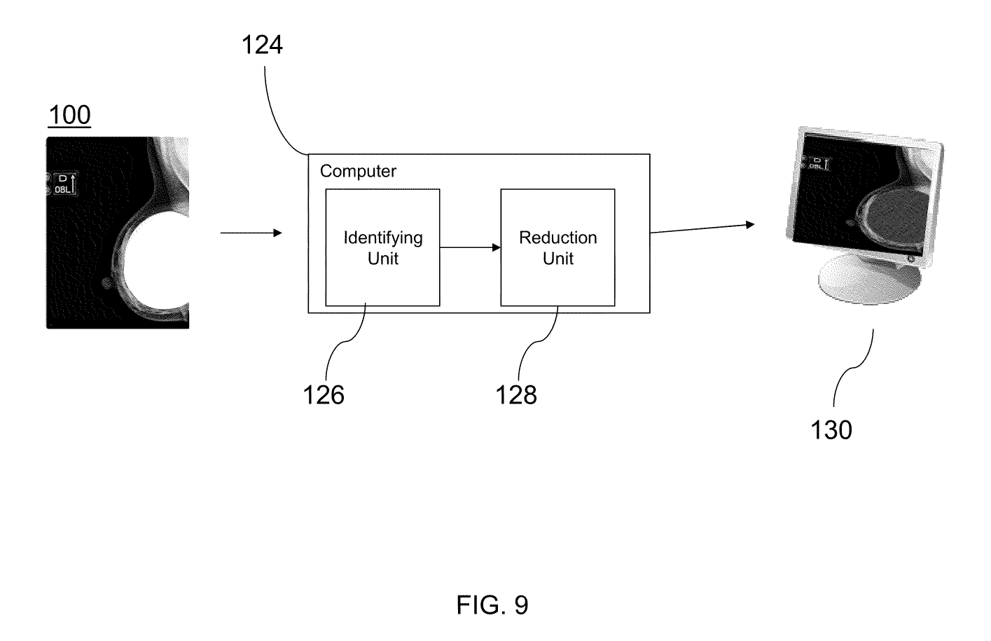

The inventive system may be implemented on a computer which receives the medical image and processes it according to the steps described above. The inventive system may be embodied as a computer program product or carried out by a combination of software and hardware. As illustrated in FIG. 9, an image 100 may be input to the computer 124 where the computer executes a program that carries out the algorithm set forth, for example, in FIGS. 6A through 6C. In executing these algorithms an identifying unit 126 identifies the at least one artificial object in the medical image. A reduction unit 128 then reduces the prominence of the artificial object to create an altered artificial object. Finally, a display unit 130 displays the medical image with the altered artificial object on a display for viewing by the user. In one non-limiting embodiment, the system provides the altered image as an option to the user, so that the user can compare the altered image to the original image.

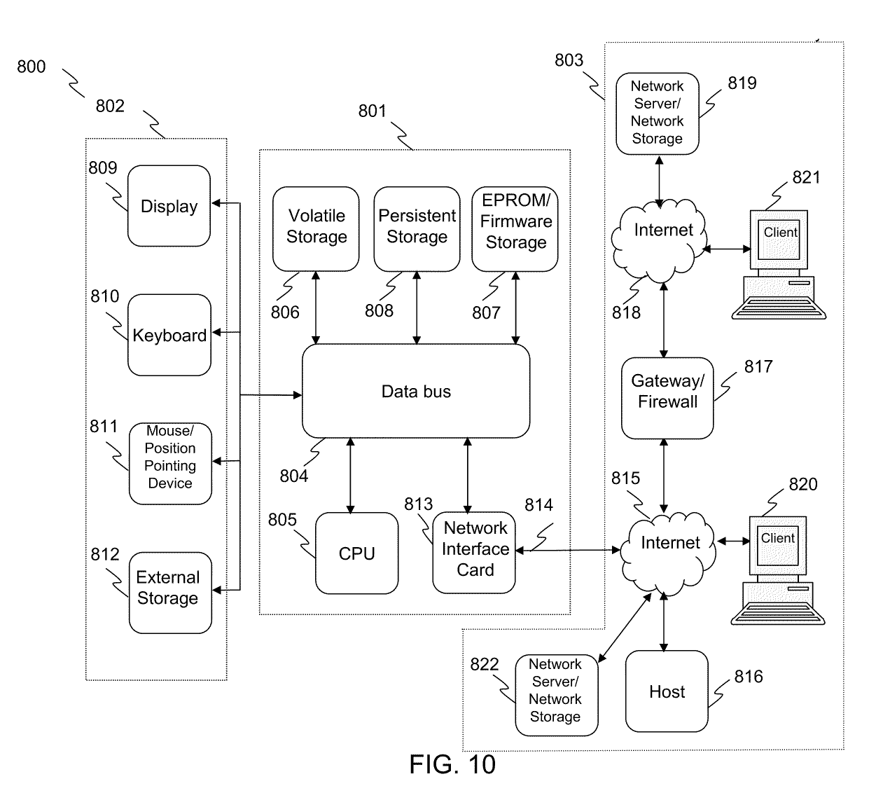

FIG. 10 is a block diagram that illustrates an embodiment of a computer/server system 800 upon which an embodiment of the inventive methodology may be implemented. The system 800 includes a computer/server platform 801, peripheral devices 802 and network resources 803.

The computer platform 801 may include a data bus 804 or other communication mechanism for communicating information across and among various parts of the computer platform 801, and a processor 805 coupled with bus 801 for processing information and performing other computational and control tasks. Computer platform 801 also includes a volatile storage 806, such as a random access memory (RAM) or other dynamic storage device, coupled to bus 804 for storing various information as well as instructions to be executed by processor 805. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 801 for storing information and instructions.

Computer platform 801 may be coupled via bus 804 to a display 809, such as a cathode ray tube (CRT), plasma display, or a liquid crystal display (LCD), for displaying information to a system administrator or user of the computer platform 801. An input device 820, including alphanumeric and other keys, is coupled to bus 801 for communicating information and command selections to processor 805. Another type of user input device is cursor control device 811, such as a mouse, a trackball, or cursor direction keys for communicating direction information and command selections to processor 804 and for controlling cursor movement on display 809. This input device typically has two degrees of freedom in two axes, a first axis (e.g., x) and a second axis (e.g., y), that allows the device to specify positions in a plane.

An external storage device 812 may be connected to the computer platform 801 via bus 804 to provide an extra or removable storage capacity for the computer platform 801. In an embodiment of the computer system 800, the external removable storage device 812 may be used to facilitate exchange of data with other computer systems.

A computer system 800 can be used for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 808. Volatile media includes dynamic memory, such as volatile storage 806. Transmission media includes coaxial cables, copper wire and fiber optics, including the wires that comprise data bus 804. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is connected to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 813 typically provides data communication through one or more networks to other network resources. For example, network link 814 may provide a connection through local network 815 to a host computer 816, or a network storage/server 817. Additionally or alternatively, the network link 813 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 814 and communication interface 813. In the Internet example, when the system 801 acts as a network server, it might transmit a requested code or data for an application program running on client(s) 820 and/or 821 through Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution. In this manner, computer system 801 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the computerized storage system. It is intended that all matter contained in the above description or shown in the accompanying drawings shall be interpreted as illustrative only and not limiting.

What is claimed is:

1. A method for altering the appearance of an artificial object in a medical image, the method comprising:
identifying at least one artificial object in a medical image;
reducing the prominence of the artificial object to create an altered artificial object; and
displaying the medical image with the altered artificial object on a display.

2. The method of claim 1, wherein reducing the prominence of the object comprises suppressing the brightness of the artificial object to reduce the prominence of the object.

3. The method of claim 2, wherein reducing the prominence of the object comprises masking out the artificial object to reduce the prominence of the object.

4. The method of claim 1, wherein reducing the prominence of the artificial object comprises covering up the artificial object with a simulated tissue image.

5. The method of claim 1, wherein identifying the at least one artificial object comprises processing the medical image using a region grow method.

6. The method of claim 1, further comprising identifying at least one artificial object for which the prominence is to be reduced by detecting all objects above a minimum threshold of brightness.

7. The method of claim 1, wherein identifying the at least one artificial object is performed automatically.

8. The method of claim 1, wherein the medical image is a mammography image containing an image of a human breast.

9. The method of claim 8, wherein the object comprises a primary object located inside an area of the breast and a secondary object located outside the area of the breast, wherein the prominence of the object is reduced by suppressing the brightness of the primary object and masking out the secondary object.

10. The method of claim 1, wherein the at least one artificial object is a pacemaker, breast implant, lead marker, BB marker, magnifier frame, or unexposed area of the medical image.

11. A system for altering the appearance of an artificial object in a medical image, the system comprising:
an identifying unit which identifies at least one artificial object in a medical image; and
a reduction unit which reduces the prominence of the artificial object to create an altered artificial object.

12. The system of claim 11, further comprising a display unit which displays the medical image with the altered artificial object on a display.

13. The system of claim 11, wherein the reduction unit reduces the prominence of the artificial object by suppressing the brightness of the artificial object.

14. The system of claim 13, wherein reduction unit reduces the brightness of the artificial object by masking out the artificial object.

15. The system of claim 11, wherein the reduction unit reduces the prominence of the artificial object by covering up the artificial object with a simulated tissue image.

16. The system of claim 11, wherein the at least one artificial object is identified using a region grow method.

17. The system of claim 11, wherein the identifying unit identifies the at least one artificial object by detecting all objects above a minimum threshold of brightness.

18. The system of claim 11, wherein the at least one artificial object is identified automatically.

19. The system of claim 11, wherein the medical image is a mammography image containing an image of the human breast.

20. The system of claim 13, wherein the object comprises a primary object located inside an area of the breast and a secondary object located in an area outside of the breast, wherein the prominence of the object is reduced by suppressing the brightness of the primary object and masking out the secondary object.

21. The system of claim 11, wherein at least one artificial object comprises a pacemaker, a breast implant, a lead marker, a magnifier frame, or a unexposed area of the medical image.

22. A computer program product for altering the appearance of an artificial object in a medical image, the computer program product embodied on a computer readable medium and when executed by a computer, performs the method comprising:
identifying at least one artificial object in a medical image;
reducing the prominence of the artificial object to create an altered artificial object; and
displaying the medical image with the altered artificial object on a display.
